(19) United States
(12) Patent Application Publication
(10) Pub. No.: US 2005/0225533 A1
(43) Pub. Date: Oct. 13, 2005

(54) Mouse

(76) Inventor: Annie Cheng, Diamond Bar, CA (US)

Correspondence Address: JOE NIEH, 18760 E. AMAR ROAD #204, WALNUT, CA, 91789, US

(21) Appl. No.: 10/823,233

(22) Filed: Apr. 13, 2004

(51) Int. Cl. G09G 5/08

(52) U.S. Cl. 345/163

(57) ABSTRACT

A mouse with built-in buttons for easily copying, cutting, and pasting selected items on the screen is disclosed. The mouse comprises of two selection buttons with a scrolling wheel between the two buttons and three buttons that are preprogrammed to perform the functions of copying, cutting, and pasting the selected items on the screen. The buttons may also be programmed to customize them to perform any desired functions.

### BACKGROUND

1. Field of Invention

The present invention relates to a computer accessory for controlling the cursor and performing various input functions. More specifically, the present invention relates to a mouse that controls the cursor and performs various input functions.

2. Description of Related Art

A basic computer system comprises of the central processing unit (CPU), memories, video graphic card, sound card, motherboard, and various peripheral input and output devices such as monitor, keyboard, mouse, modem, scanner, and printer. Input and output devices are necessary for the user to communicate with the computer. The input devices communicate information and commands from the user to the computer, and the output devices communicate information from the computer to the user. A software, generally known as the operating system, is used to control the communications between the user and the computer as well as between the computer and the various peripheral devices connected to it. The most common operating system in use today is the Microsoft Windows operating system.

A keyboard and a mouse are the most common form of input devices. The keyboard is generally used to input text and execute commands. The mouse is generally used to control the movement of a cursor and to select items shown on the monitor. In the Microsoft Windows operating system, the mouse is an indispensable input device. It performs various crucial functions such as moving the cursor, selecting various functions, and scrolling the image on the screen.

The most common type of mouse for use with the Microsoft Windows operating system comprises of a rounded body with two or more buttons on top for selection of items on the screen, a wheel between the buttons for scrolling the image on the screen, and a roller ball under the rounded body that translates the movement of the mouse into x and y coordinates for controlling the cursor on the screen. In some mouse, an optical system is used in place of the roller ball to translate the movement of the mouse into x and y coordinates. The mouse is usually connected to the computer with a wire. Some mouse use wireless transmitter and receiver to connect the mouse to the computer thereby eliminating the wire between the mouse and the computer.

The user moves the mouse in a horizontal plane on the tabletop. The movement of the mouse is translated into x and y coordinates and inputted into the computer to control the movement of a cursor on the screen. One of the most common application for computers is word processing. For word processing the mouse is used to select input location for the text and to select the text. The mouse is also used to scroll through a document to view the documents. For a large document, the user may have to scroll through page after page of text to view the desired text. On a mouse designed for Microsoft Windows operating system, a scrolling wheel between the buttons speeds up the vertical scrolling so that the user may reach the desired location in the document faster. However, once the desired text is located and selected for editing, the user must generally select a function from a pull-down menu or use a combination of shortcut keys to copy, cut, or paste the text. On some mouse, the keys may be user programmed to perform various functions but the programming of the buttons are often complicated and difficult to perform. Therefore, most of these “programmable” buttons are usually not programmed by the user to perform any function other than the default selection function.

### SUMMARY OF THE INVENTION

The present invention is a mouse with built-in buttons for easily copying, cutting, and pasting selected items on the screen. The mouse comprises of two selection buttons with a scrolling wheel between the two buttons and three buttons that are preprogrammed to perform the functions of copying, cutting, and pasting the selected items on the screen. The buttons may also be programmed to customize them to perform any desired functions.

### BRIEF DESCRIPTION OF THE DRAWINGS

FIG. 1 shows the top view of the mouse with the built-in preprogrammed buttons for performing the functions of copying, cutting, and pasting selected items on the screen.

FIG. 2 shows a schematic diagram of the micro processor circuit in the mouse.

### DETAILED DESCRIPTION OF THE PREFERRED EMBODIMENT

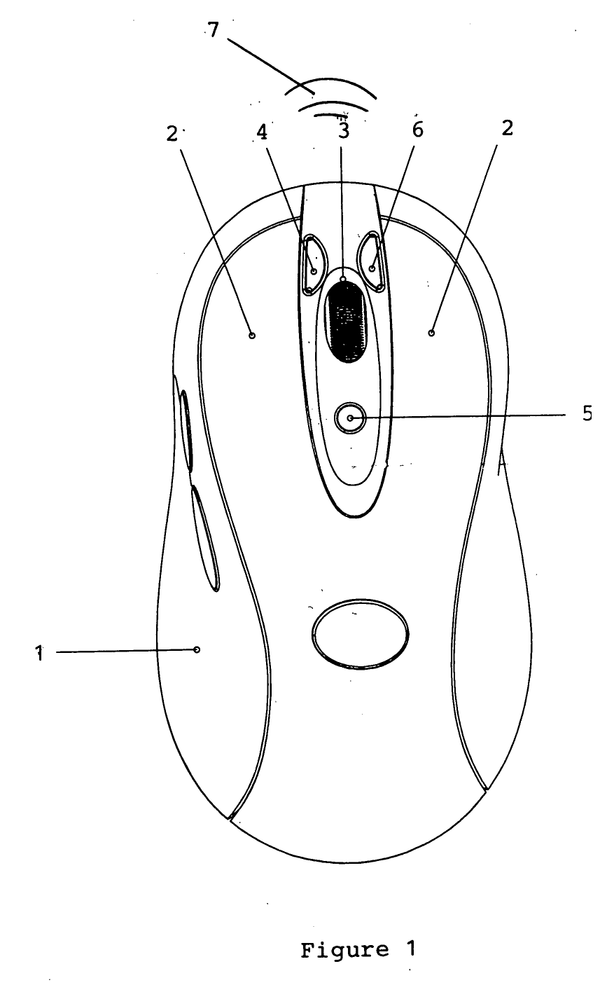

FIG. 1 shows the preferred embodiment of the present invention. The preferred embodiment of the mouse comprises of a housing 1 with a right selection button 2, a left selection button 2, a scrolling wheel 3, a copy button 4, a cut button 5, and a paste button 6 arranged on the top of the housing 1 for operation by an user's hand. The mouse may use either a roller ball or an optical system to translate the coordinates of the mouse movements to the computer. The mouse may be connected to the computer with either a wire or a wireless transmitter 7 and receiver.

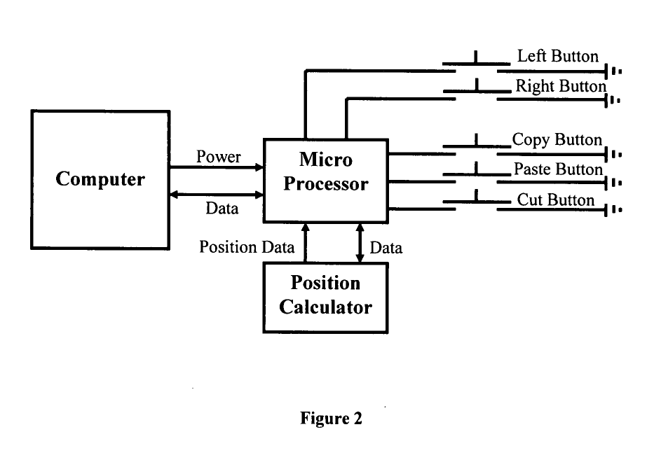

A micro processor chip is affixed within the housing 1 of the mouse to detect the pressing of the buttons 2, 4, 5, 6, the rotation of the scrolling wheel 3, and the relative movements of the mouse and processes and transfers these signals to the computer. FIG. 2 shows a schematic diagram of the micro processor in the mouse.

In the preferred embodiment of the mouse, the copy button 4, the cut button 5, and the paste button 6 are preprogrammed to perform their specific functions. These functions may also be changed by the user using software to perform other desired functions. The right selection button 2 and the left selection button 2 are preprogrammed to perform the selection function. The scrolling wheel 3 is preprogrammed to perform vertical scrolling of the documents being edited. In using the present invention, the number of presses of the buttons are greatly minimized and the user does not need to take his/her hand off the mouse to perform complicated combination of short-cut keys that must have been memorized by the user to edit a document.

Although the description above contains many specificities, these should not be construed as limiting the scope of the invention but as merely providing illustrations of some of the presently preferred embodiments of this invention. Thus the scope of the invention should be determined by the appended claims and their legal equivalents, rather than by the examples given.

1. A mouse comprising:
a housing;
one or more selection buttons disposed on the housing;
a scrolling wheel rotably disposed on the housing;
one or more buttons with preprogrammed function disposed on the housing;
a means to track the position of the mouse disposed within the housing;
a means to communicate with the computer affixed within the housing; and
a microprocessor affixed within the housing and electrically connected to said selection buttons, said scrolling wheel, said button with a preprogrammed copy function, said button with a preprogrammed cut function, and said button with a preprogrammed paste function;
wherein an user can operate the mouse with one hand to easily edit a document.

2. A mouse as in claim 1, wherein the means to track the position of the mouse is a rolling ball mainly disposed within the housing with a small portion exposed through the bottom of the housing.

3. A mouse as in claim 1, wherein the means to track the position of the mouse is a optical system affixed within the housing.

4. A mouse as in claim 1, wherein the means to communicate with the computer is a wire.

5. A mouse as in claim 1, wherein the means to communicate with the computer is a wireless transmitter and receiver.

6. A mouse comprising:
a housing;
a right selection button disposed on the housing;
a left selection button disposed on the housing;
a scrolling wheel rotably disposed between the right selection button and the left selection button on the housing;
one or more buttons with preprogrammed function disposed on the housing;
a means to track the position of the mouse disposed within the housing;
a means to communicate with the computer affixed within the housing; and
a microprocessor affixed within the housing and electrically connected to said selection buttons, said scrolling wheel, said button with a preprogrammed copy function, said button with a preprogrammed cut function, and said button with a preprogrammed paste function;
wherein an user can operate the mouse with one hand to easily edit a document.

7. A mouse as in claim 6, wherein the means to track the position of the mouse is a rolling ball mainly disposed within the housing with a small portion exposed through the bottom of the housing.

8. A mouse as in claim 6, wherein the means to track the position of the mouse is a optical system affixed within the housing.

9. A mouse as in claim 6, wherein the means to communicate with the computer is a wire.

10. A mouse as in claim 6, wherein the means to communicate with the computer is a wireless transmitter and receiver.
